(19) United States
(12) Patent Application Publication
(10) Pub. No.: US 2020/0043073 A1
(43) Pub. Date: Feb. 6, 2020

(54) GEOLOCATION-CAPABLE PHYSICAL-LOCATION RECOMMENDATION ENGINE

(71) Applicant: International Business Machines Corporation, Armonk, NY (US)

(72) Inventors: Jeremy A. Greenberger, San Jose, CA (US); Lisa Seacat DeLuca, Baltimore, MD (US)

(21) Appl. No.: 16/053,911

(22) Filed: Aug. 3, 2018

(51) Int. Cl. G06Q 30/06; G06Q 10/08; G06Q 30/02; H04W 4/021

(52) U.S. Cl. CPC G06Q 30/0631; H04W 4/021; G06Q 30/02; G06Q 10/0836

(57) ABSTRACT

A geolocation-capable recommendation engine of an ecommerce system detects that an online user has selected a product. The engine determines the user's current physical location and retrieves a log of the user's past movements at locations associated with purchasing the selected product. The engine mines the log in order to identify, as a function of a set of geolocation parameters, correlations between various extrinsic factors and the user's past activities at each location. The engine uses these correlations to identify and rank a set of candidate physical locations most likely to be preferred by the user for completing the current purchase, or for evaluating additional products recommended by the recommendation engine in response to the user's original product selection. The engine recommends to the user one or more of the candidate locations, from which the user may select a single preferred location.

### BACKGROUND

The present invention relates to ecommerce technology in general and, in particular to geolocation-capable product-recommendation engines.

Ecommerce product-recommendation technology dates back to early 1990s, with a handful of online retailers (most notably Amazon.com) and software vendors such as Net Perceptions introduced pioneering implementations based in part on research by the University of Minnesota's GroupLens Research Project.

Today, recommendation technology has become an integral part of nearly all mainstream ecommerce platforms (including Netflix, eBay, Amazon, and Apple Computer), and recommendation engines have grown enormously in complexity and sophistication. Current implementations from developers and vendors like AgentArts, Inc., ChoiceStream, Inc., and Google/Alphabet, Inc. may incorporate a combination of artificial intelligence, machine-learning, data-mining, statistical analysis, online analytics, Bayesian probability, or other cognitive and non-cognitive methods. Recommendation technology may be implemented as a home-grown or as a licensed third-party component of an ecommerce suite (such as a discrete module or an API), may be purchased from a service provider, or may be accessed as a Web service.

Recommendation technology is most often used to upsell additional products to a consumer who is shopping for, or who has already selected, items on an ecommerce Web site. But more flexible recommenders have added geolocation functionality that also recommends a physical location at which a purchaser may pick up an order, examine a desired product on the shelf, or obtain face-to-face consultation or sales support.

Geolocation-capable recommendation engines today use relatively simple means to select and recommend physical locations for such purposes. For example, a recommender may simply recommend the site that is the shortest distance from the user's physical location, that is accessible with the shortest transit time from the user's physical location, or that is in a Zip code that is in close proximity to the user's Zip code.

These mechanisms can fail to identify the site that would be preferred by a user because they determine the user's physical location in an unsophisticated manner. For example, some geolocation-capable recommenders rely on a user to manually enter a physical address into a user profile or merely set the user's physical address to the user's credit-card billing address or product-delivery address. Such mechanisms cannot accommodate users who might be physically located at any of several addresses, such as a home address, a work address, a daily commuter location (like a train station), a second home, or a vacation address.

Known ecommerce-recommender geolocation mechanisms are even less capable of considering more nuanced parameters when selecting a physical location. For example, a user may prefer to shop at a more distant location for personal reasons, such as: the more distant site's proximity to another family member's place of employment; because the more distant site is larger or newer, has more convenient parking, is less crowded, or is closer to public transportation; or because of a perceived advantage in the breadth or depth of onsite inventory or in service quality.

In other words, although geolocating ecommerce-recommendation technology may ultimately facilitate next-generation hybrid ecommerce models that integrate online channels with bricks-and-mortar resources, the relatively primitive state of current implementations limits the scope and flexibility of this potentially powerful technology.

### SUMMARY

An embodiment of the present invention is a geolocation-capable recommendation system comprising a processor, a memory coupled to the processor, and a computer-readable hardware storage device coupled to the processor, the storage device containing program code configured to be run by the processor via the memory to implement a method for a geolocation-capable physical-location recommendation engine, the method comprising:

the processor detecting that an online user of an ecommerce system has selected an item;

the processor determining a physical location of the user;

the processor selecting a set of geolocation parameters;

the processor retrieving a historical log identifying physical locations of the user throughout at least one previous duration of time;

the processor choosing a set of candidate locations by correlating values of the set of geolocation parameters extracted from the historical log with the user's current location and with the selected item;

the processor recommending the set of candidate locations to the user;

the processor receiving from the user, in response to the recommending, a specification of a preferred location; and

the processor, in response to the user's specification, directing a downstream system at the preferred location to perform a preparatory action in preparation for an arrival of the user at the preferred location.

Another embodiment of the present invention is a method for a geolocation-capable physical-location recommendation engine, the method comprising:

a processor of the geolocation-capable ecommerce recommendation engine detecting that an online user of an ecommerce system has selected an item;

the processor determining a physical location of the user;

the processor selecting a set of geolocation parameters;

the processor retrieving a historical log identifying physical locations of the user throughout at least one previous duration of time;

the processor choosing a set of candidate locations by correlating values of the set of geolocation parameters extracted from the historical log with the user's current location and with the selected item;

the processor recommending the set of candidate locations to the user;

the processor receiving from the user, in response to the recommending, a specification of a preferred location; and

the processor, in response to the user's specification, directing a downstream system at the preferred location to perform a preparatory action in preparation for an arrival of the user at the preferred location.

Yet another embodiment of the present invention is a computer program product, comprising a computer-readable hardware storage device having a computer-readable program code stored therein, the program code configured to be executed by a geolocation-capable recommendation system comprising a processor, a memory coupled to the processor, and a computer-readable hardware storage device coupled to the processor, the storage device containing program code configured to be run by the processor via the memory to implement a method for a geolocation-capable physical-location recommendation engine, the method comprising:

the processor detecting that an online user of an ecommerce system has selected an item;

the processor determining a physical location of the user;

the processor selecting a set of geolocation parameters;

the processor retrieving a historical log identifying physical locations of the user throughout at least one previous duration of time;

the processor choosing a set of candidate locations by correlating values of the set of geolocation parameters extracted from the historical log with the user's current location and with the selected item;

the processor recommending the set of candidate locations to the user;

the processor receiving from the user, in response to the recommending, a specification of a preferred location; and

the processor, in response to the user's specification, directing a downstream system at the preferred location to perform a preparatory action in preparation for an arrival of the user at the preferred location.

### BRIEF DESCRIPTION OF THE DRAWINGS

FIG. 1 depicts a cloud computing environment according to an embodiment of the present invention.

FIG. 2 depicts abstraction model layers according to an embodiment of the present invention.

FIG. 3 shows the structure of a computer system and computer program code that may be used to implement a method for a geolocation-capable physical-location recommendation engine in accordance with embodiments of the present invention.

FIG. 4 is a flow chart that illustrates steps of a method for a geolocation-capable physical-location recommendation engine in accordance with embodiments of the present invention.

### DETAILED DESCRIPTION

Ecommerce recommendation technology is an integral part of most modern ecommerce platforms. Implementations from companies like AgentArts, Inc., ChoiceStream, Inc., and Google/Alphabet, Inc. continue to grow in sophistication and functionality, often incorporating technologies like artificial intelligence, machine-learning, data-mining, statistical analysis, online analytics, Bayesian probability analysis, and other cognitive or non-cognitive methodologies. Recommendation engines may be implemented as a home-grown component of an ecommerce suite or as a licensed third-party application, cloud service, Web service, or API.

Recommendation technology was originally used solely as an upselling tool, by recommending additional products to a consumer who is shopping for, or who has already selected, items to purchase on an ecommerce Web site. Many of today's recommendation engines also offer geolocation capabilities that recommend a physical location at which an online customer may pick up an order, examine a desired product on the shelf, or obtain face-to-face consultation or sales support.

Geolocation-capable recommendation engines currently use relatively simple means to select and recommend physical locations. For example, a recommender may simply recommend a retail outlet, branch, or franchise that is the shortest distance from the user's physical location, that is accessible via the shortest transit time from the user's physical location, or that is in a Zip code that is in close proximity to the user's Zip code.

These mechanisms can thus fail to identify a site that would be preferred by a user because they use unsophisticated means to determine the user's physical location. For example, some geolocation-capable recommenders rely on a user to manually enter a physical address into a user profile or merely set the user's physical address to the user's credit-card billing address or product-delivery address. Such recommenders cannot accommodate users who are capable of being physically located at any of several addresses, such as a home address, a work address, a daily commuter location (like a train station), a second home, or a regular vacation site.

Known ecommerce-recommender geolocation mechanisms are even less capable of considering more nuanced parameters when selecting a physical location. For example, a user may prefer to shop at a more distant location for personal reasons. The more distant site may be physically convenient to a friend or family member's place of employment. The more distant site may be larger or newer, may have more convenient parking, may be less crowded, or may be closer to public transportation or to the user's daily commute route. In yet other cases, a user may prefer a particular outlet because of a perceived advantage in the breadth or depth of that outlet's onsite inventory or in the outlet's quality of customer service.

A user's location preference may also depend on other variables, such as a time of the day, a day of the week, or a category of product purchased. If, for example, one home-supplies location has a larger inventory but is more crowded than a second location, the user may prefer the first location during off-hours, but prefer the second location during prime shopping hours on weekends and weekday evenings. Similarly, if the first location has a deeper inventory of power tools and the second location has a better selection of hardwood lumber, the user's preference may depend upon whether the user plans to purchase tools or wood.

In yet other cases, a user may intend to visit a recommended physical location at a future time, where the user may be located at different physical location that future time. For example, if a user orders a washing machine during a lunch hour and intends to pick it up at the physical location after work, the user may be physically located at a place of employment at the time of the purchase and recommendation, but may be located at a distinct home address at the time that the user wishes to visit the physical location.

Many other similar examples are possible, none of which can be accommodated by current geolocation-capable ecommerce recommendation engines. In other words, although geolocating recommendation technology may ultimately facilitate next-generation hybrid ecommerce models that seamlessly integrate online channels with bricks-and-mortar resources, the relatively primitive state of current implementations restricts the applicability and flexibility of this potentially powerful technology.

The present embodiment improves upon current geolocation-capable recommendation technology by integrating instore-tracking functionality, artificial intelligence, data-mining, and other hardware and software technologies into geolocating recommendation engines.

The system can, for example, track a user's relative numbers of visits to different branches of a chain retailer, using technology embedded into each store to record the duration of time the user spends in each department during each visit. This information may then be used to correlate, or find patterns relating, the user's preferences to product categories, times of day or days of the week, local traffic conditions, weather conditions, promotional offers, the occurrence of a holiday or special event, or any other combination of parameters of interest to an ecommerce or bricks-and-mortar merchant.

Embodiments can further refine a location recommendation as a function of the user's current location, using real-time location-tracking mechanisms like IP-address triangulation or a GPS mechanism embedded into a mobile device.

Geolocation-capable embodiments can even integrate its product recommendations with its location recommendations by correlating the tracking history that enables a location recommendation with characteristics of a recommended product or service. For example, a compliant recommendation engine that responds to a user's selection of office furniture with recommendations for several lamps may select a physical location at which: i) the user has in the past browsed for both office furniture and for desktop lighting; ii) has all of the recommended lamps on display for purchase; iii) can be reached from the user's current GPS location within 30 minutes; and iv) can have the selected furniture packaged for pick up when the user arrives.

Although other stores in the same retail chain, or other stores that are part of other chains supported by the ecommerce merchant, might be physically closer to the user, these four factors suggest that the user would prefer to drive a little longer to reach what is likely to be his preferred pickup location.

These improvements do not exist in the current state of the art of geolocation-capable ecommerce recommendation technology, and thus are not well-understood, conventional, or routine in the field. Instead, they constitute a technical improvement to a technical problem of an existing computerized technology, because the architecture and design of current product-recommendation engines do not allow those engines to consider any but the most rudimentary factors when identifying and recommending physical locations.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter)

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

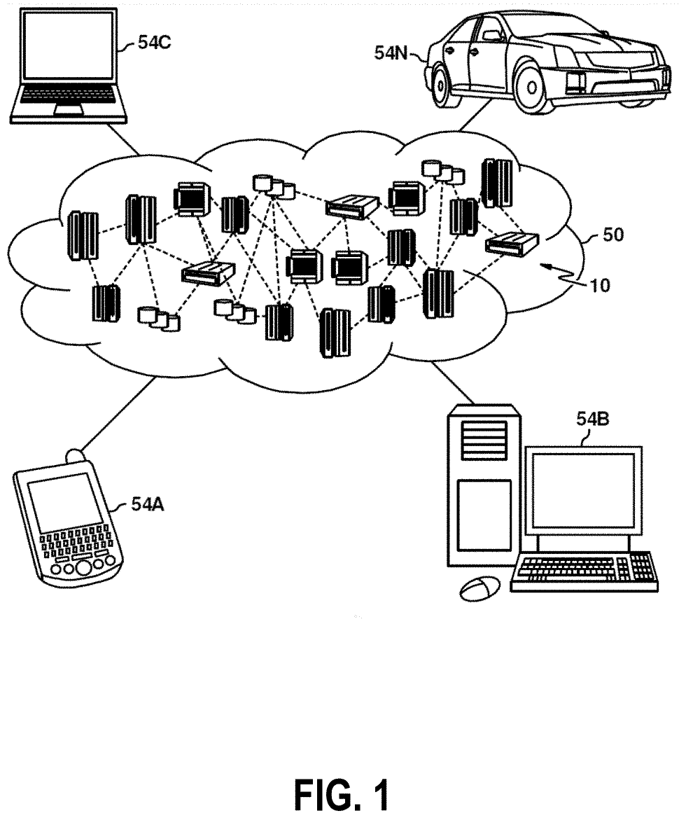

Referring now to FIG. 1, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser)

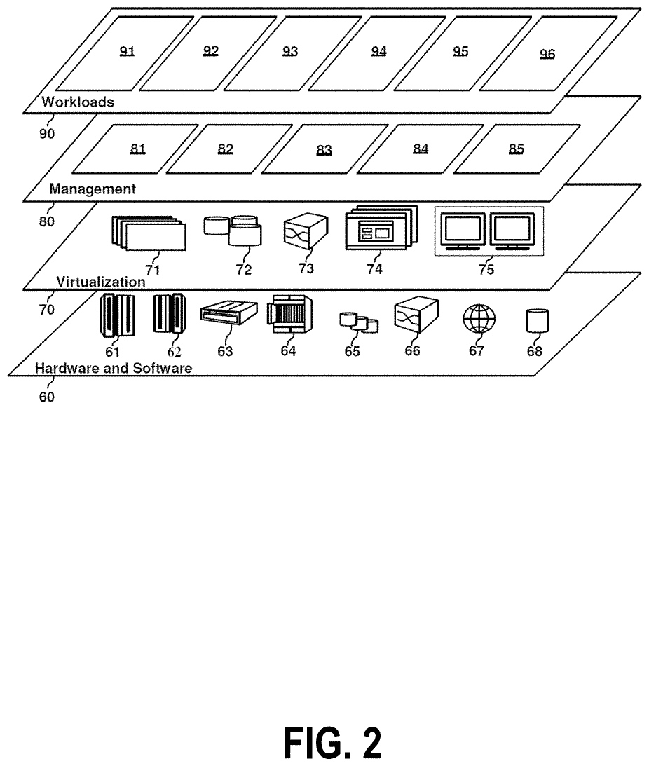

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and orchestration of a geolocation-capable ecommerce recommendation engine based on location frequency, dwell patterns, and product categories

Aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.”

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

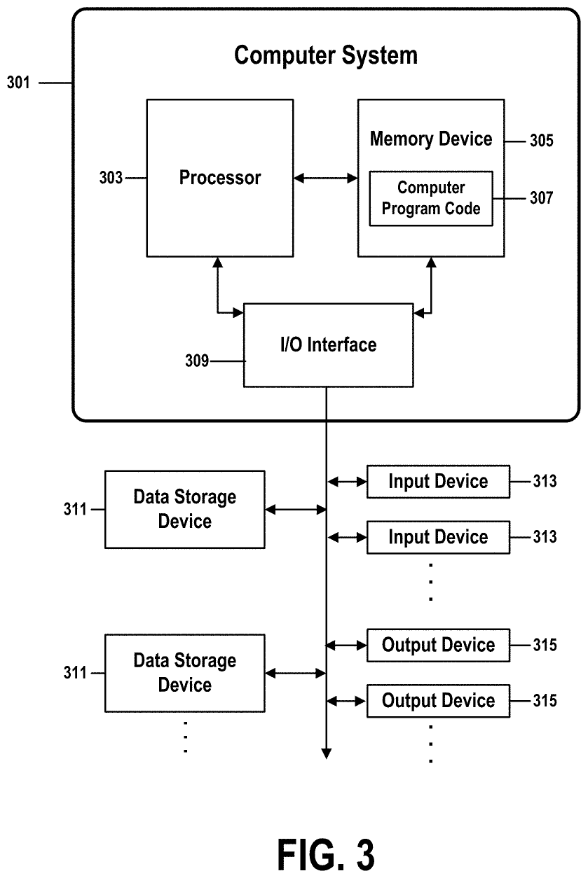

FIG. 3 shows a structure of a computer system and computer program code that may be used to implement a method for a geolocation-capable physical-location recommendation engine in accordance with embodiments of the present invention. FIG. 3 refers to objects 301-315.

In FIG. 3, computer system 301 comprises a processor 303 coupled through one or more I/O Interfaces 309 to one or more hardware data storage devices 311 and one or more I/O devices 313 and 315.

Hardware data storage devices 311 may include, but are not limited to, magnetic tape drives, fixed or removable hard disks, optical discs, storage-equipped mobile devices, and solid-state random-access or read-only storage devices. I/O devices may comprise, but are not limited to: input devices 313, such as keyboards, scanners, handheld telecommunications devices, touch-sensitive displays, tablets, biometric readers, joysticks, trackball's, or computer mice; and output devices 315, which may comprise, but are not limited to printers, plotters, tablets, mobile telephones, displays, or sound-producing devices. Data storage devices 311, input devices 313, and output devices 315 may be located either locally or at remote sites from which they are connected to I/O Interface 309 through a network interface.

Processor 303 may also be connected to one or more memory devices 305, which may include, but are not limited to, Dynamic RAM (DRAM), Static RAM (SRAM), Programmable Read-Only Memory (PROM), Field-Programmable Gate Arrays (FPGA), Secure Digital memory cards, SIM cards, or other types of memory devices.

At least one memory device 305 contains stored computer program code 307, which is a computer program that comprises computer-executable instructions. The stored computer program code includes a program that implements a method for a geolocation-capable physical-location recommendation engine in accordance with embodiments of the present invention, and may implement other embodiments described in this specification, including the methods illustrated in FIGS. 1-4. The data storage devices 311 may store the computer program code 307. Computer program code 307 stored in the storage devices 311 is configured to be executed by processor 303 via the memory devices 305. Processor 303 executes the stored computer program code 307.

In some embodiments, rather than being stored and accessed from a hard drive, optical disc or other writeable, rewriteable, or removable hardware data-storage device 311, stored computer program code 307 may be stored on a static, nonremovable, read-only storage medium such as a Read-Only Memory (ROM) device 305, or may be accessed by processor 303 directly from such a static, nonremovable, read-only medium 305. Similarly, in some embodiments, stored computer program code 307 may be stored as computer-readable firmware 305, or may be accessed by processor 303 directly from such firmware 305, rather than from a more dynamic or removable hardware data-storage device 311, such as a hard drive or optical disc.

Thus the present invention discloses a process for supporting computer infrastructure, integrating, hosting, maintaining, and deploying computer-readable code into the computer system 301, wherein the code in combination with the computer system 301 is capable of performing a method for a geolocation-capable physical-location recommendation engine.

Any of the components of the present invention could be created, integrated, hosted, maintained, deployed, managed, serviced, supported, etc. by a service provider who offers to facilitate a method for a geolocation-capable physical-location recommendation engine. Thus the present invention discloses a process for deploying or integrating computing infrastructure, comprising integrating computer-readable code into the computer system 301, wherein the code in combination with the computer system 301 is capable of performing a method for a geolocalocation-capable physical-location recommendation engine.

One or more data storage units 311 (or one or more additional memory devices not shown in FIG. 3) may be used as a computer-readable hardware storage device having a computer-readable program embodied therein and/or having other data stored therein, wherein the computer-readable program comprises stored computer program code 307. Generally, a computer program product (or, alternatively, an article of manufacture) of computer system 301 may comprise the computer-readable hardware storage device.

In embodiments that comprise components of a networked computing infrastructure, a cloud-computing environment, a client-server architecture, or other types of distributed platforms, functionality of the present invention may be implemented solely on a client or user device, may be implemented solely on a remote server or as a service of a cloud-computing platform, or may be split between local and remote components.

While it is understood that program code 307 for a method for a geolocation-capable physical-location recommendation engine may be deployed by manually loading the program code 307 directly into client, server, and proxy computers (not shown) by loading the program code 307 into a computer-readable storage medium (e.g., computer data storage device 311), program code 307 may also be automatically or semi-automatically deployed into computer system 301 by sending program code 307 to a central server (e.g., computer system 301) or to a group of central servers. Program code 307 may then be downloaded into client computers (not shown) that will execute program code 307.

Alternatively, program code 307 may be sent directly to the client computer via e-mail. Program code 307 may then either be detached to a directory on the client computer or loaded into a directory on the client computer by an e-mail option that selects a program that detaches program code 307 into the directory.

Another alternative is to send program code 307 directly to a directory on the client computer hard drive. If proxy servers are configured, the process selects the proxy server code, determines on which computers to place the proxy servers' code, transmits the proxy server code, and then installs the proxy server code on the proxy computer. Program code 307 is then transmitted to the proxy server and stored on the proxy server.

In one embodiment, program code 307 for a method for a geolocation-capable physical-location recommendation engine is integrated into a client, server, and network environment by providing for program code 307 to coexist with software applications (not shown), operating systems (not shown) and network operating systems software (not shown) and then installing program code 307 on the clients and servers in the environment where program code 307 will function.

The first step of the aforementioned integration of code included in program code 307 is to identify any software on the clients and servers, including the network operating system (not shown), where program code 307 will be deployed that are required by program code 307 or that work in conjunction with program code 307. This identified software includes the network operating system, where the network operating system comprises software that enhances a basic operating system by adding networking features. Next, the software applications and version numbers are identified and compared to a list of software applications and correct version numbers that have been tested to work with program code 307. A software application that is missing or that does not match a correct version number is upgraded to the correct version.

A program instruction that passes parameters from program code 307 to a software application is checked to ensure that the instruction's parameter list matches a parameter list required by the program code 307. Conversely, a parameter passed by the software application to program code 307 is checked to ensure that the parameter matches a parameter required by program code 307. The client and server operating systems, including the network operating systems, are identified and compared to a list of operating systems, version numbers, and network software programs that have been tested to work with program code 307. An operating system, version number, or network software program that does not match an entry of the list of tested operating systems and version numbers is upgraded to the listed level on the client computers and upgraded to the listed level on the server computers.

After ensuring that the software, where program code 307 is to be deployed, is at a correct version level that has been tested to work with program code 307, the integration is completed by installing program code 307 on the clients and servers.

Embodiments of the present invention may be implemented as a method performed by a processor of a computer system, as a computer program product, as a computer system, or as a processor-performed process or service for supporting computer infrastructure.

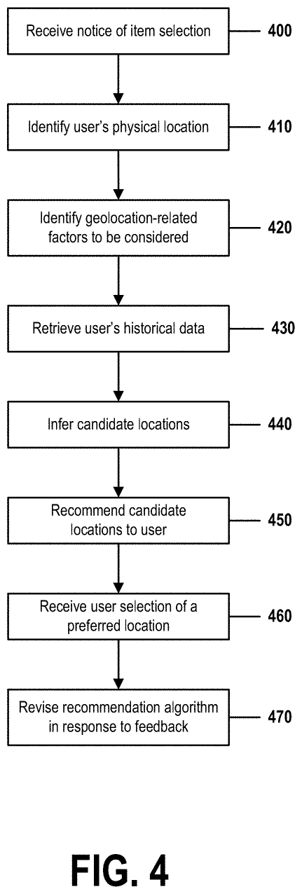

FIG. 4 is a flow chart that illustrates the steps of a method for a geolocation-capable physical-location recommendation engine in accordance with embodiments of the present invention. FIG. 4 contains steps 400-470.

In step 400, a geolocation-capable recommendation module, system, or service (referred to below as a “processor”) of an ecommerce system receives notice that a user of the ecommerce system has viewed, selected, browsed, added to a shopping cart, or otherwise taken steps toward purchasing a product or service that has been offered for sale by the ecommerce system. The recommendation module or service may be integrated into the ecommerce system or may be implemented as a standalone technology that provides recommendation services to the ecommerce system through known mechanisms, such as through API calls, a network interface, or communications with a hosted cloud service.

The notice may be received by any means known in the art, such as through internal communications between modules of the ecommerce system, through the Internet, through API or system calls, or through a messaging function of a hypervisor.

In step 410, the processor identifies the user's current physical location. This determination may be made by any means known in the art, such as by assuming that the user is currently at a physical address entered by the user as a physical delivery address or a physical billing address associated with the product identified in step 400; a physical address associated with a user profile of the user; a physical address of the user received from a global positioning system (GPS) in physical proximity to the user (such as a GPS embedded into a mobile device on the user's person or into vehicle carrying the user); a physical address inferred from an IP address of a computing device being used by the user.

In some embodiments, the system may associate multiple physical addresses with the user, such as when more than one of the above addresses exist or when a user has specified multiple physical addresses, such as a home address, one or more work addresses, a commuter location, or a vacation address. Any of these addresses may be selected by the system as a function of a calendar date, a day of the week, a time of day, or a combination thereof. For example, a user may specify that the system use a “home” physical location on nights, weekends and holidays, and a “workplace” location during weekday working hours.

When multiple candidate locations exist, the processor may consider extrinsic factors when selecting a single location from the multiple addresses. These extrinsic factors might, for example, include the current time or date, the existence of a current event (such as a holiday), comments posted by the user on a social-network site, or traffic conditions at certain of the multiple addresses.

In step 420, the processor identifies location-related factors, or geolocation parameters, that will be considered when attempting to select a user's preferred physical location in subsequent steps of the method of FIG. 4.

This identification may be accomplished by any means known in the art. An embodiment might, for example, always use a default set of parameters that have been hard-coded into the recommendation module, or may have preselected a distinct set of parameters for a particular user, type of user, product category of a selected product, geographical region or community associated with the user's physical address, or category of bricks-and-mortar shopping venues associated with the selected product.

In other cases, the identification may select a subset such a default or preselected set of parameters as a function of user input or extrinsic data, such as a current date, day of the week, time of date, extrinsic event, an interred characteristic of the user, or an online posting of the user.

The present invention is flexible enough to accommodate any selection of geolocation-related parameters desired by an implementer. Embodiments may, for example, select combinations of parameters that measure: how often the user is physically present at a particular physical location; the duration or per cent of time during which the user is physically present in a particular department when the user visits a particular physical location; the size of a particular location's onsite inventory; or the age, physical size, or accessibility of a particular location's buildings.

Embodiments may also comprise parameters that determine how likely a particular location is to be preferred by the user by correlating, or finding a pattern relating, an extrinsic factor to the times of day during which the user has in the past visited that location. For example, the processor might determine that, if a user generally visits a location only during non-rush hours, the location might be more likely to be preferred by the user when traffic conditions are light. The system might similarly correlate other extrinsic factors, such as the occurrence of specific special events or holidays, the existence as a higher-volume shopping times, the location's average checkout time at certain times of day or days of the week, the average number of available parking spaces at a particular location, or the time or day of the week at which a particular location stocks its inventory.

If desired by an implementer, any of these parameters may be assigned a weighting that indicates its relative importance to the selection of candidate physical locations. Such weightings, as well as the ultimate selection of parameters, may also be determined by business or technical priorities of the company that owns or operates the ecommerce system or of a merchant that maintains one or more of the candidate physical locations to which the recommender might direct the user.

For example, the ecommerce site might place a lower priority on certain time-of-day related parameters if the candidate physical locations identify 24-hour restaurants that are never closed. In another example, the processor might more heavily weight a parameter that considers the depth of inventory maintained by a retail store if the user's prior shopping history indicates that the user is particularly careful to consider many different options when purchasing a product. Similarly, the processor might more heavily weight a parameter that considers the depth of selection offered by a retail store in a particular product category if the user's prior shopping history indicates that the user is particularly often makes after-market purchases after purchasing a more expensive item similar to the product identified in step 400.

In step 430, the processor retrieves a historical log of the user's prior physical movements during at least one period of time. These movements may identify locations at which the user traveled during each period of time, the user's path during these periods, how long the user spent in a particular area (the “dwell time”) during these periods, the dates and times at which the user was at each physical location, and any other characteristics of the user's movements deemed relevant by an implementer.

This historical log can be created and retrieved by combinations of any means known in the art. For example, some of the user's movements may be tracked by a GPS-equipped mobile device carried on or near the user's person, and others may be tracked by sensors within retail outlets at the physical locations visited by the user. Retail outlets equipped with shelf sensors that detect when a user has handled a particular product may produce product-specific location data identifying that a user was present in a particular department or aisle of a store during a particular period of time.

This information may be provided further context by considering extrinsic data, such as a social-media posting of the user or a browser history of the user that identifies a particular retail outlet located at a physical location or that specifies an intent to visit a particular outlet at a certain time or for a certain purpose.

The historical log may be stored, updated, aggregated, or maintained by the ecommerce system locally, in a cloud resource, or by one or more merchants associated with the selected product or with one or more of the physical locations identified by the log.

In step 440, the processor infers one or more candidate physical locations from the data retrieved in step 430. These inferences may be based on values of the geolocation parameters retrieved from the retrieved data.

The candidate locations identify locations at which the user might be directed by the ecommerce system in order to complete some aspect of a purchase or review of the selected item, or of a purchase or review of an item related to the selected item and recommended by the recommendation engine.

For example, a candidate location might identify a restaurant where a user could pick up a purchased meal; a home-furnishings outlet where the user could pick up a selected piece of furniture or examine recommended products associated with the selected furniture; customer-service or sales-support location where the user might consult with a salesperson about configuring a selected vehicle, a recommended computer system, or a selected software application; or a nearby branch of an automobile-maintenance franchise where a scheduled service may be performed on the user's automobile.

Candidate locations may be inferred and ranked as functions of a combination of the historical data, the geolocation parameters, the user's current physical location, characteristics of the selected product or of suggested products, the extrinsic data, or other factors, as desired by an implementer. These inferences may be performed by means known in the art, such as by data-mining the historical log using mining criteria chosen from the geolocation parameters, a user profile, or other criteria deemed relevant by an implementer.

For example, in an embodiment that relies upon in-store tracking of a set of retail outlets, the processor may use the historical data to determine that the user has spent considerable time in the consumer-electronics departments of four outlets of the set of retail outlets. If the user's selected product is a television set, the system might rank those four outlets as a function of how frequently the user browsed for electronics in each store, or as a function of the user's average dwell time in the electronics department of each store, as a weighted average of both. If the user's selected product is in a different product category, the system would, in an analogous manner, rank candidate locations based on the user's dwell time in the department of each store that corresponds to the different category.

In a more complex example, the processor may further consider the time of day of each user visit to the four stores. If the user's dwell times in the stores' electronics departments varied significantly depending on whether the user has visited during weekend hours, and if the current day is a Saturday, then the stores with the greatest dwell times for weekend visits would be given higher priority.

Similarly, the processor might correlate traffic patterns with dwell times, determining that the user has in the past preferred stores that the user could reach with the least amount of traffic congestion. If this factor has the highest correlation with the user's past store selection, the processor might deem this factor to have the highest weighting of any geolocation parameter, or might even select candidate locations solely by this factor. In such cases, the processor would consider the user's current physical location, the current traffic conditions (perhaps retrieved from the same sources that provide traffic information to conventional GPS units), and rank candidate locations based on the relative amount of traffic congestion that the user would encounter when driving from the user's current location to each of the candidate locations.

If an implementer wishes to introduce even more nuance into the system's location-selection mechanism, this parameter might be considered only when the user's physical location indicates that the user is currently in a vehicle. In yet another example, the system might also consider the user's online postings, using known cognitive methods like semantic analysis to monitor and infer meanings to postings like “I always prefer to visit that part of town” or “The line at that drive-in is usually the shortest in town during lunch hour” or to the user's online subscriptions or “Like” and “Follow” designations.

In yet other examples, a user who is on vacation out-of-state may decide to buy a piece of furniture that the user has enjoyed at a hotel. The user orders the furniture through an online ecommerce system, but specifies that the furniture will not be picked up until the following week. The processor in this case might then infer from extrinsic information (the user's vacation schedule, as posted in the user's online calendar) that the pickup should occur at a physical location near the user's home location after the vacation concludes, rather than at the user's current out-of-state location.

Entries in a user's online calendar can also be used to identify other factors. For example, if the processor identifies a user's calendar entry suggesting that the user will be driving past a particular store at a particular time, en route to a meeting,the processor might then respond by deeming that particular store to be the user's most likely physical location.

In another example, a user who selects five products might frequent two stores at two different locations. If the first store stocks four of the five products and the second store stocks three of the five products, the processor might recommend the first store as being most likely to be the user's preferred location, even if the user generally shops at the second store.

In yet another variation, store two might instead be selected if one of the three products stocked at the second store is the only large item in the user's shopping cart. As in the previous examples, embodiments of the present invention may be tailored to the specific requirements of an implementer by setting preferences and rules that identify conditions under which the system should choose one outlet over another.

Many other similar types of correlations are possible, all of which allow a physical location to be selected by identifying correlations between various geolocation parameters and the user's previous selections of physical locations, and by then using those correlations determine how current conditions, such as the user's current location, the current availability of the currently selected product at various locations, and current extrinsic factors satisfy the identified correlations.

Embodiments of the present invention are flexible enough to accommodate any such correlations and geolocation parameters, as desired by an implementer or as deemed relevant to a specific ecommerce system, bricks-and-mortar retailer, user, or product. In simple embodiments, candidate locations may be identified merely as a function of a user's dwell time in each department of candidate physical locations. For example, if the user has selected (or has been recommended) a kitchen appliance, the processor would select and rank each candidate location as a function of the relative amount of time the user had spent in the past in the kitchenware department of each candidate location. Similarly, the processor might also (or instead) select and rank each candidate location as a function of the relative number of times or frequency with which the user had visited the kitchenware department of each candidate location.

Any of the above exemplary calculations may also be determined only during a specified duration of time, or only during a set of specified durations of time. For example, the system might consider only historical log information collected during the past year, during hours during which particular stores were open for business, or at times of day within a range similar to the current time of day.

This list of examples should not be construed to limit embodiments of the present invention to only certain types of correlations or inferred patterns. The present invention is flexible enough to accommodate any type of correlation or pattern that may be identified or inferred from the historical log and associated information by known analytical methods.

At the conclusion of step 440, the system will have identified and ranked a set of physical locations that, on the basis of the user's past behavior, have a likelihood of being the user's preferred physical location for completing tasks related to the user's current product purchase or selection on the ecommerce site.

This identification may be accomplished by any means known in the art, such as by data-mining recipient data stored in the ecommerce system's user profile or online activity log, or by tracking the recipient's online behavior on other ecommerce sites or on a social-media service.

In step 450, the processor recommends one or more of the candidate locations to the user. This recommendation may be made by any means known in the art and supported by the ecommerce system. For example, the processor may direct the ecommerce system to enumerate the location list on the user's display device during checkout or prior to checkout (as when displaying the contents of an ecommerce cart), as a text message on a mobile device, on the display of an Internet-of-Things device in a car or residence, or as a hyperlinked button in the ecommerce user interface that the user is invited to click.

The enumerated locations may be displayed in ranked order, such that the location deemed most likely to be the use's preferred location in step 440 is listed firs may be displayed in an another order, such as being ordered by relative distance from the user's present location, in alphabetical order, in random or arbitrary order, or ordered as a function of a geolocation parameter. In some embodiments, only the highest-ranked location or locations may be displayed.

The system may also in this step provide additional information about the recommended locations, such as a text description, photographs, virtual-reality tours, product-availability information, hours of operation, contact information, directions, or a link to a merchant-information page.

In step 460, the processor may receive feedback from the user selecting a preferred location from the candidate locations displayed in step 450. If more than one location was listed in step 450, the user may select the preferred location from list. If only one location was presented, the user may select that location in order to initiate further preparatory procedures, as described below.

Some embodiments may allow the user to reject all candidate locations displayed in step 450, or to manually enter an alternate preferred location. In some cases, a location must be displayed in some manner, as when the location identifies a pickup point. In other cases, the system may still be able to proceed despite the user's refusal to accept or specify a preferred location. For ample, if the locations specify sites at which a user may physically examine the recommendation engine's suggested products, then the user may be able to reject all sites, thereby rejecting all recommend products, and purchase only the product originally selected by the user.

If the user does select a preferred physical location, the system may respond by initiating one or more actions taken in preparation for the user's visit to the preferred location. These actions may be configured to accommodate the user's estimated travel time to the preferred location.

The particular sequence preparatory actions may be performed as a function of contextual factors, such as the type of product associated with the user's visit to the preferred location, the intent or goal of the user's visit, or any factors associated with the geolocation parameters, an extrinsic factor related to the geolocation factors, a characteristic of the user, or a characteristic of the preferred location.

For example, if the user has purchased the selected item, the preparatory actions may comprise directing a downstream inventory-management or sales-support system at the preferred location to prepare the selected item for pickup at the preferred location at a particular time. If the user has requested pre-sales or post-sales assistance related to the selected product, the preparatory actions may comprise directing a customer-support system at the preferred location to alert a customer-service representative that the user will quire service at the preferred location at a particular time.

In other examples, the preparatory actions may comprise directing downstream systems to prepare paperwork for the user's purchase of the selected item at the preferred location, to ensure that a recommended product is available for onsite examination by the user at the preferred location, or to confirm that the selected product is available for purchase at the preferred location.

Embodiments of the present invention are flexible enough to accommodate any other type of preparatory action that is required by a workflow employed by the ecommerce merchant or by a bricks-and-mortar retailer, wholesaler, marketer, support organization, sales organization, distributor, or other business at the preferred location.

In step 470, the processor uses feedback received from the user in step 460 to update the location-identification procedure of steps 420-440. If, for example, the user rejects all candidate locations, the system may attempt to identify characteristics of the alternate location specified by the user in order to determine why the alternate location was preferred. In some embodiments, the system may request information from a user explaining why the user preferred a location that was not identified by the processor in step 450.

In some embodiments, users may be allowed to provide other types of feedback may be possible, such as a request for more information, a request for more location recommendations, or a request for specific locations that satisfy a certain set of user-specified criteria.

If the consumer does select a preferred location from the displayed list of candidates, the system may increase the weighting of factors by which the preferred location had been selected by the processor as a candidate.

These responses to user feedback may be performed by any means known in the art for automatically updating inferential, pattern-matching, machine-learning, or other types of self-adjusting computerized decision-making mechanisms.

The processor may, throughout steps of the method of FIG. 4, communicate with other components of the ecommerce system. The processor may, for example, request and receive information about the user, the selected product, or the recommendation engine's recommended products, and may return information related to the geolocation-enabled selection of preferred or candidate locations to the ecommerce system for future storage and analysis. The processor may intercept or complement steps of the ecommerce system's product-ordering procedure in order to communicate location recommendations to the purchaser, or may request and receive notice of the purchaser's final location selection via the user-interface of the ecommerce system.

The processor may exchange information with other elements of the ecommerce system in other ways, depending on implementation, such as by instructing the ecommerce system to reply to a user request for more product information in step 460. This close coupling is a function of the fact that the present invention, an improved ecommerce-recommendation engine, whether implemented as a software module, an API, a distinct application, or a cloud service, is a functional element of an ecommerce system, and represents an improvement both to existing recommendation technology and to ecommerce technology itself, where the improvement is not well-understood, routine, or conventional in the field of ecommerce.

Examples and embodiments of the present invention described in this document have been presented for illustrative purposes. They should not be construed to be exhaustive nor to limit embodiments of the present invention to the examples and embodiments described here. Many other modifications and variations of the present invention that do not depart from the scope and spirit of these examples and embodiments will be apparent to those possessed of ordinary skill in the art. The terminology used in this document was chosen to best explain the principles underlying these examples and embodiments, in order to illustrate practical applications and technical improvements of the present invention over known technologies and products, and to enable readers of ordinary skill in the art to better understand the examples and embodiments disclosed here.

What is claimed is:

1. A geolocation-capable recommendation system comprising a processor, a memory coupled to the processor, and a computer-readable hardware storage device coupled to the processor, the storage device containing program code configured to be run by the processor via the memory to implement a method for a geolocation-capable physical-location recommendation engine, the method comprising:
the processor detecting that an online user of an ecommerce system has selected an item;
the processor determining a physical location of the user;
the processor selecting a set of geolocation parameters;
the processor retrieving a historical log identifying physical locations of the user throughout at least one previous duration of time;
the processor choosing a set of candidate locations by correlating values of the set of geolocation parameters extracted from the historical log with the user's current location and with the selected item;
the processor recommending the set of candidate locations to the user; and
the processor receiving from the user, in response to the recommending, a specification of a preferred location.

2. The system of claim 1, where the physical location of the user is selected from the group consisting of:
a product-delivery address specified by the user,
a billing address specified by the user,
a physical address received from a global positioning system (GPS) in physical proximity to the user, and
a previously entered physical address stored by the ecommerce system in a user profile.

3. The system of claim 1, where each parameter of the set of geolocation parameters is selected from the group consisting of:
a frequency at which the user is physically present a particular physical location,
a duration of time during which the user is physically present in a particular department of a particular physical location,
an identification of a size of a particular location's onsite inventory,
an identification of a particular location's age,
an identification of a particular location's physical size, and
a correlation between an extrinsic factor and a time of day during which the user is physically present at a particular physical location, where the extrinsic factor is selected from the group consisting of:
a traffic condition,
a special event,
a characterization of the time of day as a higher-volume shopping time,
a characterization of the time of day as a commuter-rush time,
an average checkout wait time of a particular location,
an average number of open parking spaces at a particular location, and
a time or date at which a particular location refreshes its inventory.

4. The system of claim 1, where the choosing further comprises:
further correlating the values with the user's current location and with one or more suggested products recommended by the product-recommendation system.

5. The system of claim 1,
where the correlating comprises identifying how often that a particular physical location of the set of candidate locations has in the past been a shopping location of the user when a certain set of conditions exists, and
where the certain set of conditions comprises a specific combination of the user's physical location prior to each past trip of the user to the particular physical location, of an item purchased during each past trip of the user to the particular physical location, and of values of the set of geolocation parameters during each past trip of the user to the particular physical location.

6. The system of claim 1, where the preferred location is comprised by the set of candidate locations.

7. The system of claim 1, further comprising:
the processor, in response to the user's specification, directing a downstream system at the preferred location to perform a preparatory action in preparation for an arrival of the user at the preferred location,
where the preparatory action is selected from the group consisting of:
preparing the selected item for pickup at the preferred location at a particular time,
alerting a customer-service representative that the user will require service at the preferred location at a particular time,
preparing paperwork for the user's purchase of the selected item at the preferred location,
ensuring that a recommended product is available for onsite examination by the user at the preferred location, and
confirming that the selected item is available for purchase at the preferred location.

8. A method for a geolocation-capable physical-location recommendation engine, the method comprising:
a processor of the geolocation-capable ecommerce recommendation engine detecting that an online user of an ecommerce system has selected an item;
the processor determining a physical location of the user;
the processor selecting a set of geolocation parameters;
the processor retrieving a historical log identifying physical locations of the user throughout at least one previous duration of time;
the processor choosing a set of candidate locations by correlating values of the set of geolocation parameters extracted from the historical log with the user's current location and with the selected item;
the processor recommending the set of candidate locations to the user; and
the processor receiving from the user, in response to the recommending, a specification of a preferred location.

9. The method of claim 8, where the physical location of the user is selected from the group consisting of:
a product-delivery address specified by the user,
a billing address specified by the user,
a physical address received from a global positioning system (GPS) in physical proximity to the user, and
a previously entered physical address stored by the ecommerce system in a user profile.

10. The method of claim 8, where each parameter of the set of geolocation parameters is selected from the group consisting of:
a frequency at which the user is physically present at a particular physical location,
a duration of time during which the user is physically present in a particular department of a particular physical location,
an identification of a size of a particular location's onsite inventory,
an identification of a particular location's age,
an identification of a particular location's physical size, and
a correlation between an extrinsic factor and a time of day during which the user is physically present at a particular physical location, where the extrinsic factor is selected from the group consisting of:
a traffic condition,
a special event,
a characterization of the time of day as a higher-volume shopping time,
a characterization of the time of day as a commuter-rush time,
an average checkout wait time of a particular location,
an average number of open parking spaces at a particular location, and
a time or date at which a particular location refreshes its inventory.

11. The method of claim 8, here the choosing further comprises:
further correlating the values with the user's current location and with one or more suggested products recommended by the product-recommendation system.

12. The method of claim 8,
where the correlating comprises identifying how often that a particular physical location of the set of candidate locations has in the past been a shopping location of the user when a certain set of conditions exists, and
where the certain set of conditions comprises a specific combination of the user's physical location prior to each past trip of the user to the particular physical location, of an item purchased during each past trip of the user to the particular physical location, and of values of the set of geolocation parameters during each past trip of the user to the particular physical location.

13. The method of claim 8, further comprising:
the processor, in response to the user's specification, directing a downstream system at the preferred location to perform a preparatory action in preparation for an arrival of the user at the preferred location,
where the preparatory action is selected from the group consisting of:
preparing the selected item for pickup at the preferred location a particular time,
alerting a customer-service representative that the user will require service at the preferred location at a particular time,
preparing paperwork for the user's purchase of the selected item at the preferred location,
ensuring that a recommended product is available for onsite examination by user at the preferred location, and
confirming that the selected item is available for purchase at the preferred location.

14. The method of claim 8, further comprising providing at least one support service for at least one of creating, integrating, hosting, maintaining, and deploying computer-readable program code in the computer system, wherein the computer-readable program code in combination with the computer system is configured to implement the detecting, the determining, the selecting, the retrieving, the choosing, the recommending, and the receiving.

15. A computer program product, comprising a computer-readable hardware storage device having a computer-readable program code stored therein, the program code configured to be executed by a geolocation-capable recommendation system comprising a processor, a memory coupled to the processor, and a computer-readable hardware storage device coupled to the processor, the storage device containing program code configured to be run by the processor via the memory to implement a method for a geolocation-capable physical-location recommendation engine, the method comprising:
the processor detecting that an online user of an ecommerce system has selected an item;
the processor determining a physical location of the user;
the processor selecting a set of geolocation parameters;
the processor retrieving a historical log identifying physical locations of the user throughout at least one previous duration of time;
the processor choosing a set of candidate locations by correlating values of the set of geolocation parameters extracted from the historical log with the user's current location and with the selected item;
the processor recommending the set of candidate locations to the user; and
the processor receiving from the user, in response to the recommending, a specification of a preferred location.

16. The computer program product of claim 15, where the physical location of the user is selected from the group consisting of:
a product-delivery address specified by the user,
a billing address specified by the user,
a physical address received from a global positioning system (GPS) in physical proximity to the user, and
a previously entered physical address stored by the ecommerce system in a user profile.

17. The computer program product of claim 15, where each parameter of the set of geolocation parameters is selected from the group consisting of:
a frequency at which the user is physically present a particular physical location,
a duration of time during which the user is physically present in a particular department of a particular physical location,
an identification of a size of a particular location's onsite inventory,
an identification of a particular location's age,
an identification of a particular location's physical size, and
a correlation between an extrinsic factor and a time of day during which the user is physically present at a particular physical location, where the extrinsic factor is selected from the group consisting of:
a traffic condition,
a special event,
a characterization of the time of day as a higher-volume shopping time,
a characterization of the time of day as a commuter-rush time,
an average checkout wait time of a particular location,
an average number of open parking spaces at a particular location, and
a time or date at which a particular location refreshes its inventory.

18. The computer program product of claim 15, where the choosing further comprises:
further correlating the values with the user's current location and with one or more suggested products recommended by the product-recommendation system.

19. The computer program product of claim 15,
where the correlating comprises identifying how often that a particular physical location of the set of candidate locations has in the past been a shopping location of the user when a certain set of conditions exists, and
where the certain set of conditions comprises a specific combination of the user's physical location prior to each past trip of the user to the particular physical location, of an item purchased during each past trip of the user to the particular physical location, and of values of the set of geolocation parameters during each past trip of the user to the particular physical location.

20. The computer program product of claim 15, further comprising:
the processor, in response to the user's specification, directing a downstream system at the preferred location to perform a preparatory action in preparation for an arrival of the user at the preferred location,
where the preparatory action is selected from the group consisting of:
preparing the selected item for pickup at the preferred location at a particular time,
alerting a customer-service representative that the user will require service at the preferred location at a particular time,
preparing paperwork for the user's purchase of the selected item at the preferred location,
ensuring that a recommended product is available for onsite examination by the user at the preferred location, and
confirming that the selected item is available for purchase at the preferred location.
